(19) United States
(12) Patent Application Publication
(10) Pub. No.: US 2009/0223344 A1
(43) Pub. Date: Sep. 10, 2009

(54) A musical string

(75) Inventor: Peter Infeld, Wien (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: Thomastik-Infeld Gesellschaft m.b.H., 1050 Wien (AT)

(21) Appl. No.: 12/109,737

(22) Filed: Apr. 25, 2008

(30) Foreign Application Priority Data
Mar. 7, 2008 (EP) 08450031.3

(51) Int. Cl. G10D 3/10

(52) U.S. Cl. 84/297 S

(57) ABSTRACT

For achieving a high tuning stability and a clear and radiant sound it is provided in a musical string (1), especially for plucked and/or stringed instruments, with the musical string (1) having at least one core (2) and with the musical string (1) having at least one sheathing (3) which is arranged about the first core (2), that the core comprises a predeterminable plurality of plastic cm 1 fibers (4).

The invention relates to a musical cord according to the preamble of claim 1.

Known musical cords with a core made of natural gut or silk have a number of disadvantages such as low tuning stability and large differences between the actually similar products due to the high form tolerances which are unavoidable in natural products. Such musical cords further show a number of acoustic problems. The sound producible with such musical cords meets requirements of current concert operations only within limits.

It is therefore the object of the invention to provide a musical cord of the kind mentioned above with which the mentioned disadvantages can be avoided and which especially offers high tuning stability and clear and radiant sound.

This is achieved in accordance with the invention by the features of claim 1.

A musical cord can accordingly be formed which has a very natural, clear and radiant sound and a low weight of sound post, as a result of winch baroque and medieval stringed instruments are not overtaxed excessively. Moreover, such a musical cord has a high tuning stability and it is not necessary to re-tune the instrument as frequently as conventional musical cords. Musical cords in accordance with the invention also respond less strongly than known musical cords to a change of location and changes in weather.

The sub-claims which like claim 1 simultaneously form a part of the description relate to further advantageous embodiments of the invention.

The invention is now explained in closer detail by reference to the enclosed drawings which merely show preferred embodiments in an exemplary manner, wherein:

FIG. 1 shows a first preferred embodiment of a musical cord in accordance with the invention in a sectional view;

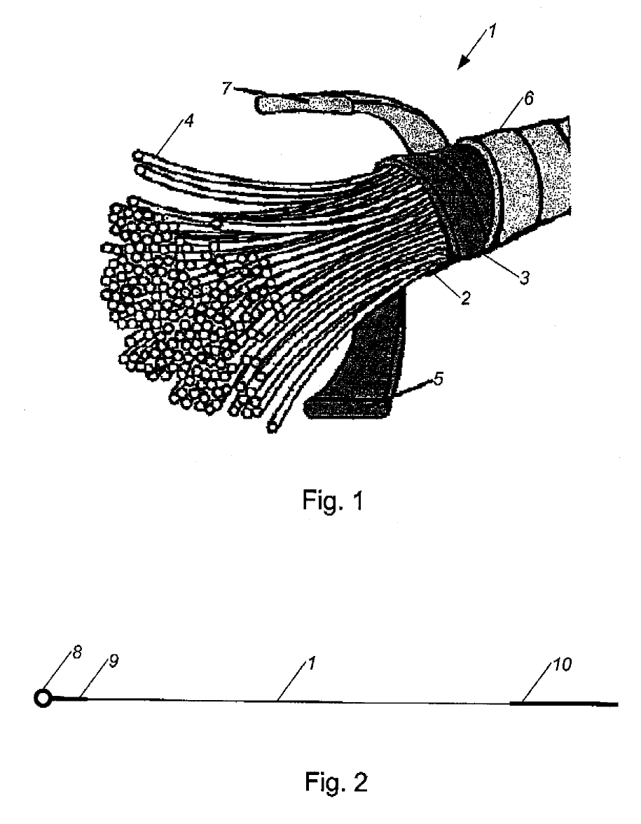

FIG. 2 shows a musical cord in accordance with the invention in a complete view;

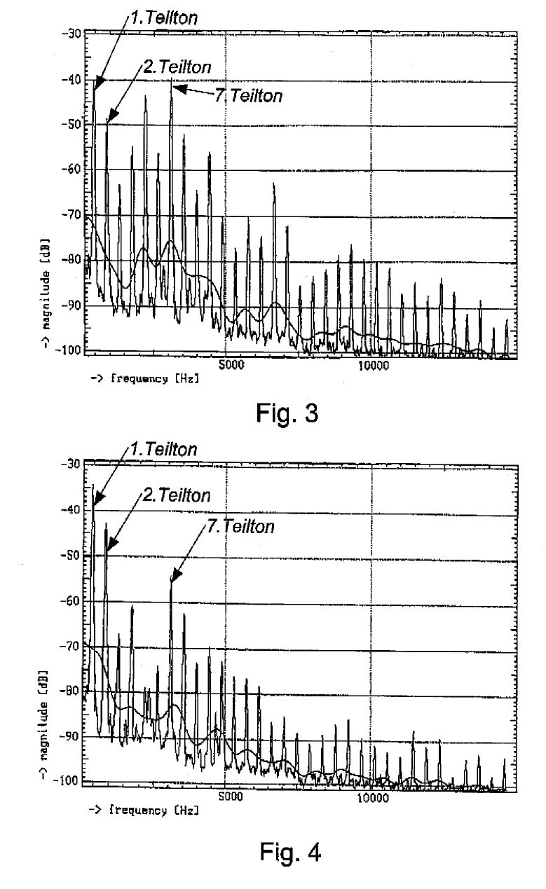

FIG. 3 shows a first frequency spectrum of an oscillation of a first musical cord in accordance with the invention;

FIG. 4 shows a second frequency spectrum of an oscillation of a second musical cord in accordance with the invention;

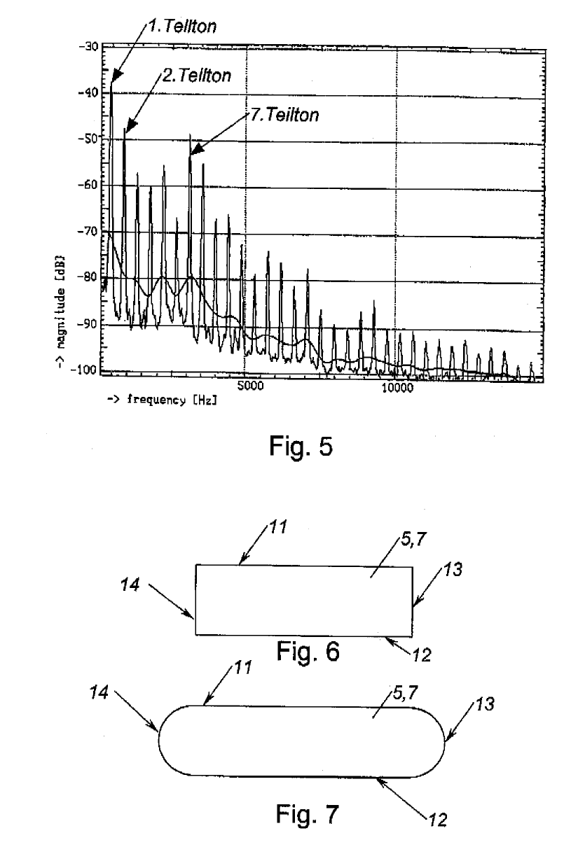

FIG. 5 shows a third frequency spectrum of an oscillation of a third musical cord in accordance with the invention;

FIG. 6 shows a first preferred embodiment of a strip in a cross section;

FIG. 7 shows a second preferred embodiment of a strip in a cross section;

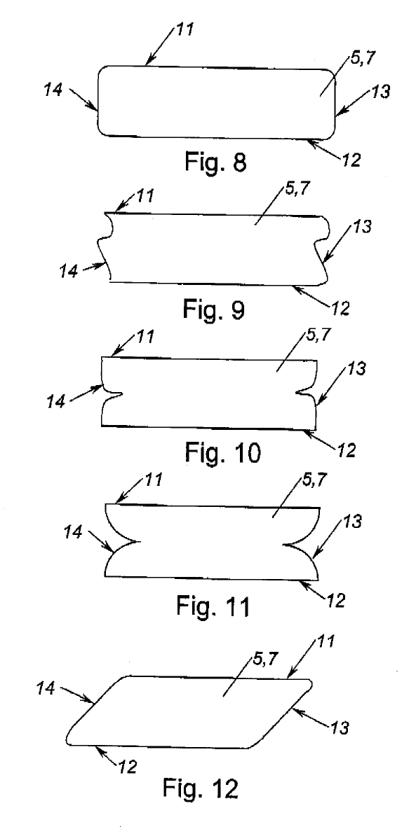

FIG. 8 shows a third preferred embodiment of a strip in a cross section;

FIG. 9 shows a fourth preferred embodiment of a strip in a cross section;

FIG. 10 shows a fifth preferred embodiment of a strip in a cross section;

FIG. 11 shows a sixth preferred embodiment of a strip in a cross section;

FIG. 12 shows a seventh preferred embodiment of a strip in a cross section;

FIGS. 1 and 2 show a musical cord, especially for stringed and/or plucked instruments, with the musical cord 1 having at least one core 2 and with the musical cord 1 having at least one first sheathing 3 which is arranged about the first core 2, with the core comprising a predeterminable plurality of plastic fibers 4. A musical cord 1 can thus be formed which has a very natural, clear and radiant sound and has a low weight of sound post, as a result of which baroque and medieval stringed instruments are not overtaxed excessively. Moreover, such a musical cord 1 has a high tuning stability and it is not necessary to re-tune the instrument as frequently as conventional musical cords. Musical cords 1 in accordance with the invention also respond less strongly than known musical cords to a change of location and changes in weather.

The various embodiments shown in the drawings are shown in a simplified view. The proportions need not correspond to the intended real proportions. Individual parts can be shown in a highly enlarged view for offering improved understanding. Individual figures can show embodiments of the musical cord 1 which do not show all features relevant for the invention if this serves the purpose of better and clearer illustration. Such illustrations or embodiments are not in contravention of the invention.

A preferred field of use for such musical cords 1 are the instruments of the family of violins such as the violin, viola, cello and bass and contrabass. Further preferred instruments for using the musical cords 1 in accordance with the invention are guitars and mandolins. Such musical cords 1 in accordance with the invention can be provided for all stringed and plucked instruments such as cembalos, harps, banjos, sitars, dulcimers, zithers, lutes, oods, p'i-p'as, gekkins, balalaikas, vinas, tampuras, kotos, sohs, etc.

Musical cords 1 in accordance with the invention are provided for generating sound-making oscillations, with a musical cord 1 being provided for use in a specific musical instrument and further have a concert pitch and sound post as features, with the concert pitch determining the sound with which a portion of the musical cord 1 will oscillate (between its end sections) from the length of the scale of the musical instrument for which it is provided when the musical cord 1 is loaded with the sound post and is therefore tensioned.

Musical cords 1 generally have a means for mounting the musical cord 1 on a part of the respective musical instrument. This means for mounting can be formed in simple embodiments by a loop or a knot in the musical cord 1. It is preferably provided, as shown in FIG. 2, that the musical cord 1 is delimited at a first end by a sleeve or a ball which especially comprise metal and which is generally also designated as button 8. The musical cord 1 further comprises preferably at least at one end a so-called wrapping 9, 10. It is especially preferably provided as shown in FIG. 2 that the musical cord 1 comprises a first wrapping 9 at its first end and a second wrapping 10 at its second end 10 which protects the musical cord 1 from excessive edge load during mounting on the pegs of a musical instrument. The wrappings 9, 10 which are often arranged in colors are preferably made of artificial and/or natural fibers, especially artificial or natural silk with a fineness between 50 dtex and 1000 dtex. The end of the fiber is usually tightly glued after forming the wrapping 9, 10 or will adhere as a result of the natural attraction forces on the wrapping. It can further be provided that instead of at least one of the wrappings 9, 10 the musical cord is protected by an elastic coating which is applied by immersing the first and/or second end of the musical cord 1 into a dipping bath. The coating preferably comprises an elastomer, especially comprising natural caoutchouc or latex. By coating the ends of a musical cord in accordance with the invention, the production of such a musical cord can be simplified substantially because in this way a complex process with a fast-rotating machine can be replaced by the simple lowering of a musical cord into a dipping bath. Production costs and the likelihood of injury during production are lowered. The labeling of the different musical cords 1 is supported by the color arrangement.

The musical cords 1 in accordance with the invention have a core 2 which is provided and arranged to absorb the load or tension to which the musical cord 1 is subjected in a state when tensioned on a musical instrument. The core 2 of a musical cord 1 in accordance with the invention comprises a predeterminable plurality of plastic fibers 4 or is made of such plastic fibers 4. Any kind of plastic fiber 4 can be provided, e.g. such comprising polymer fibers, especially comprising polyamides, aramide fibers, PEK, PEEK, PBT, polyester, nylon, polyethylene, PET, PEET, PES, PE, PP, POM, PTFE, PVDF, PVDC and/or PVC. It is provided in an especially preferred way and as in the final described preferred embodiments of a musical cord 1 in accordance with the invention that the plastic fibers 4 are made of polyamide 6.4, 6.6, 6.10 or 6.12 with a fineness of 180 dtex to 250 dtex or of polyester PES with a fineness between 1000 dtex and 1150 dtex. Combinations of different plastic fibers 4 within the core 2 of a musical cord 1 can be provided. It can be provided for example that a core 2 of a musical cord 1 has a share of 40% to 43% of plastic fibers 4 made of polyamide 6.4 with a fineness of approx. 195 dtex and the remainder of the plastic fibers 4 is made of polyamide 6.10 with a fineness of approx. 237 dtex.

In accordance with the invention, any arrangement of the plastic fibers 4 can be provided within the core 2. It has been seen that the musical cords 1 in accordance with the invention have especially advantageous acoustic properties when the plastic fibers 4 are arranged in the form of bundles and the core 2 comprises a predeterminable number of such bundles. An especially advantageous inner damping of the musical cord 1 can thus be achieved, as a result of which such musical cords 1 can be controlled very well by a bow in the case of an excitation by such a bow and respond quickly to a change of bow. It has proven to be advantageous that the core 2 comprises between five and twenty-five bundles. It is provided in an especially preferable way that the core 2, depending on the type of the musical cord, comprises between 6 and 12 bundles for musical cords 1 for higher pitches or violins or violas, and between 18 and 25 bundles for musical cords 1 for lower pitches or for cellos or contrabasses.

The number of plastic fibers 4 per bundle also allows influencing the damping for the musical cord 1 in a predeterminable way. It has proven to be especially advantageous for musical cords 1 for string instruments that each bundle comprises between twenty and sixty plastic fibers 4.

The individual bundles which together form the core 2 of the musical cord 1 can be arranged to lie next to one another in an especially simple embodiment. It has been seen that it is especially advantageous for improving the homogeneity of the oscillation properties of the musical cord 1 when the predeterminable number of bundles for forming the core 2 are twisted in to a predeterminable extent. It is preferably provided here that the bundles are twisted in with between ten and eighty complete rotations. It can thus be achieved, depending on the requirements placed on the musical cord 1, that they have the same properties during the down-bow and up-bow, or different properties. The up-bow concerns the excitation of the musical cord 1 by means of a bow, with the bow being guided during playing from the tip to the frog along the musical cord. The down-bow concerns a movement opposite thereto, with the bow moving from the frog to the tip over the musical cord 1.

Musical cords 1 in accordance with the invention comprise at least a first sheathing 3. Said first wrapping 3 can be arranged as any kind of sheathing, winding or sheathing of the musical cord 1. It is provided in an especially preferable way that the first sheathing 3 is wound in a helical way about the core 4. This leads to an especially advantageous way of increasing the mass cover of musical cord 1. The bending stiffness of the musical cord 1 can be kept at an advantageously low level as a result of the helical arrangement of sheathing 3. In this way, the formation of a large number of high partial tones is enabled during the excitation of the musical cord 1, thus enabling a play rich in tone colors with such a musical cord 1.

It is provided in a helical arrangement of the first sheathing 3 that the first sheathing 3 consists of at least a first round wire or at least a first strip 5 of a substantially rectangular cross section with predeterminable edge arrangement. The first round wire or the first strip 5 are wound during production of the musical cord 1 on the core 2. It can be provided that the first round wire or the first strip 5 are wound so as to lie close to one another, with no cavities occurring substantially between the individual adjacent windings. It can also be provided that a predeterminable cavity is provided between the individual adjacent windings. By arranging the first sheathing 3 as a round wire or as a first strip 5, an especially simple production of the musical cord 1 can be achieved.

It can be provided in a further development of the invention that the first sheathing 3 further comprises a second round wire and that the first round wire and the second round wire are wound lying adjacent to one another in a helical way about the core 2, or that the first sheathing 3 further comprises a second strip with a substantially rectangular cross section with a predeterminable edge formation, and that the first strip 5 and the second strip are wound lying adjacent to one another in a helical manner about the core 2. The bending stiffness of the musical cord 1 can be lowered at a substantially unchanged mass coating, as a result of which the richness of tone colors that can be achieved with such a musical cord 1 can be increased.

The round wire can concern any kind of round wire. It is provided especially that the at least one round wire has a diameter of between 0.05 mm and 0.4 mm. It can further be provided that the at least one round wire has a substantially straight circumferential line at least in sections. Such a substantially straight circumferential line can be formed by grinding off a sheathing formed from round wires. The special properties of round wires can thus be combined with those of a strip.

Furthermore, each strip 5, 7 can be provided for forming the sheath. It is preferably provided that the at least one strip 5, 7 is between 1.25 and 30 times as thick as it is wide.

The strip 5, 7 with a substantially rectangular cross section with predeterminable edge formation preferably concerns a strip 5, 7 with a cross section which essentially has the dimensions of a rectangle, with the formation of the edges of the strip 5, 7 being predeterminable. FIGS. 6 to 12 show seven especially preferred embodiments of a strip 5, 7 in a cross-sectional view. The first preferred embodiment of a strip 5, 7 according to FIG. 6 has a substantially rectangular cross section in the mathematical sense. The tolerances of parallelism of the individual surfaces and deviations of the angles between the mutually adjacent surfaces 11, 12, 13, 14 being provided within the range of the usual production tolerances.

The second and third preferred embodiments of a strip 5, 7 according to FIGS. 7 and 8 have a cross section which has two parallel surfaces which are substantially in the range of production tolerances and which have the shape of a cover surface 11 and a bottom surface 12, with the lateral surfaces 13, 14 being arranged as a so-called natural edge. Such a strip is formed for example by rolling a wire without aftertreatment of the lateral surfaces 13, 14. The lateral surfaces 13, 14 preferably have a shape which is formed from a predeterminable sequence of predeterminable conic section lines. The third preferred embodiment of a strip 5, 7 in accordance with FIG. 8 has lateral surfaces which are substantially arranged in a planar way in sections.

The fourth, fifth and sixth preferred embodiments of a strip 5, 7 according to FIGS. 9, 10 and 11 have a cross section which is formed by special rolling processes. As a result of different shapes, formerly unattainable acoustic and playing properties in musical cords 1 can be achieved. A strip 5, 7 according to the fourth preferred embodiment comprises a first lateral surface 13 and a second lateral surface 14 which are shaped in such a way that in the case of a helical winding of the strip 5, 7 onto a core 2 of a musical cord 1, with the first lateral surface 13 being arranged substantially directly adjacent to the second lateral surface 14, the first lateral surface 13 grasps behind the adjacent second lateral surface 14 at least in sections, so that an assembly is formed. The lift-off of individual windings from the strip 5, 7 can thus be prevented. Furthermore, the penetration of dirt beneath a sheathing can be prevented, which sheathing is formed by a strip 5, 7 according to the fourth preferred embodiment.

The fifth and sixth preferred embodiment of a strip 5, 7 according to FIGS. 10 and 11 each have a first and second lateral surface 13, 14 which faces towards the inside of the cross section or is arranged in a concave manner. Regions can thus be created in which additional damping or bonding agents can be arranged. Damping agents are preferably viscopolymer liquids. The preferred bonding agents mentioned at another place can be provided as bonding agents. The inner damping of the musical cord 1 can thus be increased in a predeterminable manner, as a result of which such a musical cord 1 can be controlled better when excited by playing.

The seventh preferred embodiment of a strip 5, 7 according to FIG. 12 has a cross section in which the first lateral surface 13 and the second lateral surface 14 are arranged substantially parallel with respect to one another relative to the cover surface 11 or bottom surface 13, thus enabling a shingle-like arrangement of the windings of a sheathing 3, 6 which are arranged next to one another. The penetration of dirt can thus be effectively prevented, which thus further increases the service life of the musical cords 1.

Each of the strips 5, 7 described in the present descriptions preferably has a cross section according to one of the previously described seven preferred embodiments.

In respect of the further described especially preferred embodiments, detailed examples for especially advantageous dimensioning of round wires and strips 5, 7 for the musical cords 1 in accordance with the invention are mentioned, so that a further listing of preferred embodiments can be omitted here.

It is preferably provided that the at least one round wire or the at least one strip 5, 7 is arranged to comprise a metallic material. This combines the advantages of a high density and rough surface which is advantageous for excitation by a bow because colophony adheres specially well on such a rough surface. It is provided in an especially preferred way that the at least one round wire or the at least one strip 5, 7 is formed to comprise at least one material from the group of aluminum, magnesium, iron, chromium, nickel, silicon, silver, gold, platinum, rhodium, copper, tungsten, with each of the mentioned materials being provided as a pure material in the technical sense, but also as a component of an alloy. Musical cords 1 have proven to be especially advantageous in which the at least one round wire or the at least one strip 5, 7 is formed to comprise at least one alloy chosen from the group of steel, aluminum/magnesium alloys, aluminum/magnesium/manganese alloys, silver/copper alloys, silver/platinum alloys, silver/rhodium alloys, silver/palladium alloys, iron/chromium/nickel/silicon/aluminum alloys, with further details in connection with a number of the mentioned alloys being discussed in the description of the preferred embodiments. Steel preferably concerns steel comprising alloy components chosen from the group of carbon, chromium, nickel, molybdenum, vanadium, manganese, tungsten, with carbon steels (carbon content of 0.01% to 0.03%) and chromium/nickel steels (chromium content of 17% to 20%, nickel content of 8% to 10%) being especially preferable. It can further be provided that the at least one round wire or the at least one strip 5, 7 has a surface coating, with a coating being provided with at least one metal, especially brass, tin, nickel, and/or a plastic, especially a polymer.

It can preferably be provided that a predeterminable number of coatings can be arranged above one another.

In a further development of the invention it is provided especially preferably that a musical cord 1 in accordance with the invention has a second sheathing 6 which is wound in a helical manner about the first sheathing 3, through which advantageously a further mass coating can be applied to the same without excessively increasing the bending stiffness of the musical cord 1. The second sheathing 6 which is preferably formed from a third round wire or a third strip 7 with a substantially rectangular cross section can be applied in the same winding sense as the preceding first sheathing 3 or in a winding sense which is contrary to or crosses the winding sense of the first sheathing 3. This shall be referred to below as “crossed”. As a result of the crossed arrangement of the second sheathing 6 relative to the first sheathing 3, an especially homogeneous musical cord 1 can be formed. FIG. 1 shows such a musical cord 1 with a first and second sheathing 3, 6.

It can be provided in an equivalent manner to the arrangement of the first sheathing 3 that the second sheathing 6 further comprises a fourth round wire and that the third round wire and the fourth round wire are wound lying next to one another in a helical manner about the core 2, or that the second sheathing 6 further comprises a fourth strip with a substantially rectangular cross section and that the third strip 7 and the fourth strip are wound lying next to one another in a helical manner about the core 2. The arrangement of the round wires or strips 7 is preferably arranged in an equivalent manner to the embodiments described in the description of the first sheathing 3.

As in two of the preferred embodiments described further below, it is preferably provided that the musical cords 1 in accordance with the invention comprise at least a third sheathing which is wound in a helical manner about the second sheathing 6. It can also be provided in this case that the third sheathing is arranged in a crossed manner relative to the second sheathing 6. The arrangement of the round wires or strips is preferably arranged in an equivalent manner to the embodiments described in the description of the first sheathing 3.

Furthermore, a predeterminable number of further sheaths can be provided, with especially a fourth, fifth and sixth sheathing being provided which are all preferably arranged in an equivalent manner to the embodiments described in the description of the first sheathing 3 as regards arrangement, dimensioning and materials.

It can further be provided that a polymer coating is provided as the outermost layer of musical cord 1, e.g. in form of a plastic tube or a so-called bi-stage lacquer. It is preferably provided in this case that a polymer cover tape is wound up onto the musical cord 1 in a helical manner. In this context it is provided preferably that the edges of the polymer cover tape arranged helically on the musical cord are molten together. It is provided for this purpose to subject the musical cord 1 to a predeterminable heating. A jacket about the musical cord 1 is closed which is impenetrable for dirt and humidity, thus further increasing the service life of the musical cord.

It can be provided that the first sheathing 3 is arranged directly on the core 2 and that the further provided sheaths are arranged to follow directly one after the other. It can also be provided that a bonding agent is arranged, preferably comprising wax, especially natural waxes such as bees wax or carnauba wax and/or artificial waxes such polyolefin waxes, paraffin, oil, such as greasy oils, mineral oil, and/or synthetic oils such as resin, especially natural resins such as larch resin and/or spruce resin, and/or synthetic resins such as polyester resin, phenol resin and/or epoxy resin. Such a bonding agent can also be arranged between core 2 and the first sheathing 3. The bonding agent can be used to change the inner damping of the musical cord 1 in a predeterminable way, especially to increase the same, which is especially advantageous for musical cords 1 for strings.

A number of especially preferred embodiments of a musical cord 1 in accordance with the invention will be described below:

Core 2 of the especially preferred embodiments of musical cords 1 in accordance with the invention as described below are formed from seven or eight bundles with approx. 30 to 40 plastic fibers 4 each, unless stated otherwise. The plastic fibers 4 preferably concern polyamide 6.4, 6.6, 6.10 and/or 6.12 which preferably have a fineness of 180 dtex to 250 dtex. The seven or eight bundles are twisted between 22 and 30 complete twists in the preferred embodiments as described below.

The first, second, third and fourth preferred embodiment of a musical cord 1 in accordance with the invention each comprise a first sheathing 3 which is formed from a first strip 5 made of an aluminum/magnesium alloy which is wound in a helical manner about the core 2. The respectively provided further sheathing 6 comprises a third strip 7 which is arranged substantially identical to the first strip 5 and is formed from the same aluminum/magnesium alloy and which is arranged in a crossed manner relative to the first strip 5, with an oil/wax mixture being arranged at least in sections between the first and third strip 5, 7. The aluminum/magnesium alloy is preferably an aluminum/magnesium alloy chosen from the group of AlMg 1.5, AlMg 3, AlMg 3.5 Mn, AlMg 5, AlMg 4.5 Mn.

In the first preferred embodiment of a musical cord 1 in accordance with the invention, the first and third strip 5, 7 has a thickness of between 0.05 mm and 0.065 mm and a width of between 0.18 and 0.21 mm.

In the second preferred embodiment of a musical cord 1 in accordance with the invention, the first and third strip 5, 7 has a thickness of 0.1 mm and 0.13 mm and width of between 0.2 mm and 0.23 mm.

In the third preferred embodiment of a musical cord 1 in accordance with the invention, the first and third strip 5, 7 has a thickness of between 0.035 mm and 0.055 mm and width of between 0.18 and 0.21 mm.

In the fourth preferred embodiment of a musical cord 1 in accordance with the invention, the first and third strip 5, 7 has a thickness of between 0.085 mm and 0.11 mm and width of between 0.18 and 0.215 mm.

The described first, second, third and fourth preferred embodiment of a musical cord 1 in accordance with the invention therefore comprises a first sheathing 3 made of a first strip 5 and a second sheathing 6 made of a third strip 7, with the first and third strip 5, 7 being made from an aluminum/magnesium alloy (preferably one and the same) or an aluminum/magnesium/manganese alloy, with the first and third strip 5, 7 having cross sections which are substantially identical with respect to each other, with the first and third strip 5, 7 being 1.7 and 5.5 times as wide as thick, and with the third strip 7 being arranged in a crossed manner relative to the first strip 5.

Said first, second, third and fourth preferred embodiment of a musical cord 1 in accordance with the invention are especially preferably suitable for use as musical cords 1 for violins and/or violas with fundamental tone or concert pitch a¹ (440 Hz) or d¹ (293.7 Hz at tune of a¹ to 440 Hz). In addition to the already described advantages of musical cords 1 in accordance with the invention, the common feature of these preferred embodiments (and especially the first preferred embodiment in this respect) is that the second or seventh partial tone has a larger amplitude or is arranged more strongly than the other partial tones. An exception can obviously be the first partial tone which is also known as the fundamental tone. It was managed to verify this especially advantageous behavior which is relevant for the especially characteristic sound of the respective musical cords 1 in a series of comprehensive comparative tests. The enclosed FIGS. 3, 4 and 5 each show the frequency spectrum of an individual such musical cord 1 as a graph of the amplitude over the frequency, with the first, the second and the seventh partial tone having been marked, and with the seventh partial tone being recognizable which is clearly developed in an especially strong way. Moreover, these embodiments have partial tones which are developed strongly in the higher frequency ranges. Such musical cords 1 therefore have an especially radiant sound which is rich in tone colors and thus offer the musician wide possibilities for musical expression and virtuosity.

In the fifth preferred embodiment of a musical cord 1 in accordance with the invention, the first sheathing 3 is arranged as in the fourth preferred embodiment as described above. The second sheathing 6 is arranged from a third strip 7 comprising silver, with the silver preferably being provided with a purity grade of 99.999% or 99.6%, or a silver alloy chosen from the group of AgCu, AgCu 2, AgCu 6, AgPt 16, AgKh 16. The third strip 7 comprises a thickness of between 0.11 mm and 0.125 mm and a width of between 0.206 mm and 0.22 mm. As in the fourth preferred embodiment, the third strip 7 is also arranged in a crossed manner relative to the first strip 5 in the fifth preferred embodiment of a musical cord 1.

In a sixth preferred embodiment of a musical cord 1 in accordance with the invention, the first sheathing 3 is made of a first strip 5 and a second strip which are wound adjacent to one another in a helical manner about the core 2. The first strip 5 and the second strip are arranged in a substantially identical manner relative to each other, have a thickness of between 0.05 mm and 0.065 mm and a width of between 0.2 and 0.218 mm, and are formed to comprise an alloy made of nickel and copper, especially NiCu 30. The second sheathing 6 is arranged as a third strip 7 which is arranged in a crossed manner relative to the first strip 5 and the second strip. The third strip 7 is arranged to comprise aluminum, especially comprising one of the above described aluminum/magnesium alloys, and has a thickness of between 0.08 mm and 0.1 mm and width of between 0.205 mm and 0.22 mm.

In a seventh and eighth preferred embodiment of a musical cord 1 in accordance with the invention, the first sheathing 3 is formed from a first round wire which has a diameter of between 0.125 mm and 0.145 mm and comprises tungsten. The first round wire is enclosed by a second sheathing 6 which is formed from a third strip 7 which has a thickness of between 0.05 mm and 0.065 mm and has a width of between 0.28 mm and 0.31 mm. The third strip 7 which comprises silver or a silver alloy and is arranged according to the statements made in connection with the fifth preferred embodiment is arranged in a crossed manner relative to the first round wire. The seventh preferred embodiment has the described core 2 with seven or eight bundles of plastic fibers, like all previously described preferred embodiments of musical cords 1 in accordance with the invention. The eighth preferred embodiment comprises a core 2 that comprises nine or ten bundles, with the further arrangement of core 2 of the eighth embodiment of a musical cord being identical with the above described seven preferred embodiments.

The ninth and tenth preferred embodiment of a musical cord 1 in accordance with the invention which preferably comprises a core 2 according to the first even preferred embodiments each comprise a first sheathing 3 which are formed from a first and second round wire and which are wound adjacent to one another in a helical manner about the core 2, with the first and second round wire being arranged in a substantially identical manner relative to one another.

In the ninth preferred embodiment of a musical cord 1 in accordance with the invention, the first and second round wire are formed to comprise an iron/chromium/nickel/silicon/aluminum alloy which is also known as a so-called beating conductor alloy and have a diameter of between 0.11 mm and 0.145 mm. A second sheathing 6 is arranged on the first sheathing 3 which is arranged as a third strip 7 with a preferred thickness of between 0.055 mm and 0.7 mm and a width of between 0.28 mm and 0.33 mm and comprises silver or a silver alloy according to the statements made in connection with the fifth preferred embodiment.

The tenth preferred embodiment of a musical cord 1 in accordance with the invention comprises a first sheathing 3 comprising a first and second round wire which have a diameter of between 0.11 and 0.145 mm and are formed from a nickel base alloy, preferably with a nickel content of between 99.2% or 99.6%. A second sheathing 6 is arranged on the first sheathing 3 thus formed, which second sheathing is formed from a third and fourth round wire which are arranged according to the first and second round wire according to the above described ninth preferred embodiment, with the third and fourth round wire being arranged adjacent to one another in a helical manner and crossed relative to the first and second round wire on the same. A third sheathing is arranged on the second sheathing 6, which third sheathing is arranged as a fifth strip comprising silver or a silver alloy according to the statements made in connection with the fifth preferred embodiment, and has a preferred thickness of between 0.06 mm and 0.074 mm and width of between 0.29 mm and 0.312 mm. The fifth strip is arranged in a crossed manner relative to the third and fourth round wire on the same. It is preferably provided that between the second sheathing 6 and the third sheathing an oil/wax mixture is arranged at least in sections.

The further described eleventh, twelfth, thirteenth and fourteenth preferred embodiment of a musical cord 1 in accordance with the invention have the common feature of a core 2 which has between twenty and twenty-five bundles, each with between 30 and 40 of the already explained plastic fibers 4, instead of the already explained embodiments with 7 or 8 or 9 or 10 bundles comprising plastic fibers 4.

The eleventh preferred embodiment of a musical cord 1 in accordance with the invention comprises a first sheathing which is formed from a first strip 5 and a second strip which are formed comprising an iron/chromium/nickel/silicon/aluminum alloy and have a thickness of between 0.027 mm and 0.031 mm and a width of the between 0.2 mm and 0.23 mm. The first strip 5 and the second strip are arranged adjacent to one another in a helical manner on core 2. In addition to said first sheathing arranged in this manner, a second sheathing 6 is arranged in a crossed manner comprising a third strip 7 with a thickness of between 0.027 mm and 0.03 mm and width of between 0.5 mm and 0.555 mm, with a liquid resin being arranged between the first and second sheathing 3, 6 at least in sections. The third strip 7 is preferably made of the same material as the first strip 5 and the second strip.

In the twelfth preferred embodiment of a musical cord 1 in accordance with the invention, the first sheathing 3 is made from a first, second and fifth round wire which are arranged substantially identical with respect to each other, have a diameter of between 0.07 mm and 0.082 mm and are made of steel, especially so-called carbon steel. In addition to the first sheathing 3 arranged in this way, a second sheathing 6 is arranged in a crossed manner comprising a third strip 7 with a thickness of between 0.049 mm and 0.055 mm and a width of between 0.5 mm and 0.555 mm and being formed from an iron/chromium/nickel/silicon/aluminum alloy, with a wax being arranged at least in sections between the first and second sheathing 3, 6.

The thirteenth preferred embodiment of a musical cord 1 in accordance with the invention comprises a first sheathing 3 which is formed from a first and second round wire which are arranged to comprise steel, especially so-called carbon steel, and have a diameter of between 0.1 mm and 0.135 mm. In addition to this first sheathing 3 arranged in this way there is arranged in a crossed manner a second sheathing 6 comprising a third strip 7 with a thickness of between 0.11 mm and 0.14 mm and a width of between 0.235 mm and 0.25 and being formed from a nickel or a nickel base alloy, with liquid resin being arranged at least in sections between the first and second sheathing 3, 6.

The fourteenth preferred embodiment of a musical cord 1 in accordance with the invention has an arrangement which is substantially identical to the above described thirteenth preferred embodiment, with the third and second round wire merely having a diameter of between 0.177 mm and 0.199 mm and the third strip 7 having a thickness of between 0.22 mm and 255 mm and a width of between 0.375 mm and 0.383 mm.

The above described musical cord 1 in accordance with the invention is especially advantageous as musical cords 1 for cellos.

The described ninth, thirteenth and fourteenth preferred embodiments of a musical cord 1 in accordance with the invention therefore have a first sheathing 3 which is formed from a first and second round wire which are wound adjacent to one another in a helical manner about the core 2, with the first and second round wire having a diameter of between 0.1 mm and 0.2 mm which are substantially identical with respect to each other, with the second sheathing 6 being formed from a third strip 7 which is between 1.5 times and 5.5 times as thick as wide. Musical cords 1 can thus be formed which combine a highly focused sound with a very rapid response. Rapid response shall preferably be understood in such a way that such a musical cord 1 will very rapidly assume an oscillating state corresponding to the type of excitation in the case of excitation by means of a bow. Such musical cords further have an advantageously low bending stiffness.

The above described sixth and eleventh preferred embodiment of a musical cord in accordance with the invention therefore comprises a first sheathing 3 which is formed from a first strip 5 and second strip which are wound adjacent to one another in a helical manner about the core 2, with the first strip 5 and the second strip being 3 to 8 times as wide as thick, and with the second sheathing 6 being formed from a third strip 7. Such musical cords 1 have a very wide, brilliant and supportive sound.

Finally, a fifteenth preferred embodiment of a musical cord 1 in accordance with the invention is described. It comprises a core 2 which in contrast to the above described preferred embodiment is made of polyester PES with a tex between 1000 dtex and 1150 dtex, with an arrangement of the individual plastic fibers 4 in bundles being provided. An intermediate layer comprising polyamide is arranged between the first sheathing 3 and the core 2. It is provided especially preferably that a bundle, preferably with 20 to 35 polyamide fibers with a tex of between 95 dtex and 115 dtex, is wound in a helical way about the core 2. A first sheathing 3 is arranged on said intermediate layer which is formed from a first, second and fifth round wire which are arranged substantially identically with respect to each other and have a diameter of between 0.15 mm and 0.165 mm and are made of steel, especially so-called carbon steel, with the first, second and fifth round wire being arranged in a crossed manner relative to the intermediate layer.

A second sheathing 6 is arranged on the first sheathing 3, which second sheathing is made from a third and fourth round wire which have diameters in the range of between 0.31 mm and 0.325 mm which are substantially identical to one another. The third and fourth round wire are arranged as a copper wire, with the third round wire being arranged as a blank copper wire, having a surface which is substantially free from coatings, and with the fourth round wire having a surface coating. It is especially provided that the fourth round wire has a plastic coating. The fourth round wire concerns in an especially preferable way a so-called lacquer-coated copper wire. The copper wire preferably concerns any wire comprising at least 99% copper. The second sheathing 6 is arranged in a crossed manner relative to the first crossing 3, with the third and fourth round wire being arranged adjacent to one another in a helical manner about the first sheathing 3.

The third sheathing is arranged in a crossed manner again on said second sheathing 6, which third sheathing is formed from a sixth, seventh and eighth round wire which are all arranged identically with respect to one another, have a diameter of between 0.355 mm and 0.368 mm and are made of steel, preferably of carbon steel. The sixth, seventh and eighth round wire are wound adjacent to one another in a helical manner about the second sheathing 6 arranged beneath them.

A fifth and sixth strip is provided as a fourth and final sheathing of said specially preferred fifteenth embodiment of a musical cord 1 in accordance with the invention, which strips are arranged identically with respect to one another and have a thickness in the range between 0.16 mm and 0.175 mm and a width in the range of between 0.622 mm and 0.638 mm. The fourth sheathing is arranged in a crossed manner relative to the third sheath, with the fifth and sixth strip being arranged adjacent to one another in a helical manner about the third sheath. The fifth and six strip are preferably made from a material comprising nickel. Nickel alloys are especially preferred which have a nickel content of more than 99.2% and/or the nickel alloys NiMn 2.

A bonding agent, preferably comprising natural wax and oil, is arranged between the third and fourth sheath, preferably at least in sections. It can further be provided that a further sheathing is arranged between the second sheathing 6 and the third sheath, which further sheathing is arranged in a substantially identical manner to the second sheathing 6.

The described fifth preferred embodiment of a musical cord 1 in accordance with the invention has a very high mass coating as are result of the numerous superimposed sheaths, which is why this musical cord 1 is especially suitable for low-frequency oscillations.

Further embodiments in accordance with the invention merely have a part of the described features. Any combination of features can be provided, especially such from different described embodiments.

1. A musical string (1), especially for stringed and/or plucked instruments, with the musical string (1) having at least one core (2) and with the musical string (1) having at least a first sheathing (3) which is arranged about the first core (2), characterized in that the core has a predeterminable plurality of plastic fibers (4).

2. A musical string (1) according to claim 1, characterized in that the core (2) has a predeterminable number of bundles, and that each bundle is formed by a predeterminable number of plastic fibers (4).

3. A musical string (1) according to claim 2, characterized in that the core (2) comprises between five and twenty-five bundles.

4. A musical string (1) according to claim 2 or 3, characterized in that the each bundle comprises between twenty and sixty plastic fibers (4).

5. A musical string (1) according to one of the claims 2 to 4, characterized in that the predeterminable number of bundles for forming the core (2) are twisted to a predeterminable extent, with preferably between ten and eighty complete twists being provided.

6. A musical string (1) according to one of the claims 1 to 5, characterized in that the plastic fibers (4) are arranged as polyamide fibers, especially comprising polyamide 6.4, polyamide 6.6, polyamide 6.10 and/or polyamide 6.12.

7. A musical string (1) according to one of the claims 1 to 5, characterized in that the plastic fibers (4) are arranged as polyester fibers, especially comprising PES.

8. A musical string (1) according to one of the claims 1 to 7, characterized in that the first sheathing (3) is wound in a helical manner about the core (4).

9. A musical string (1) according to one of the claims 1 to 8, characterized in that the first sheathing (3) is made of at least a first round wire.

10. A musical string (1) according to claim 9, characterized in that the first sheathing (3) further comprises a second round wire, and that the first round wire and the second round wire are wound adjacent to one another in a helical manner about the core (2).

11. A musical string (1) according to one of the claims 1 to 8, characterized in that the first sheathing (3) is formed by at least a first strip (5) with a substantially rectangular cross section with predeterminable edge formation.

12. A musical string (1) according to claim 11, characterized in that the first sheathing (3) further comprises a second strip with a substantially rectangular cross section with predeterminable edge formation, and that the first strip (5) and the second strip are wound adjacent to one another in a helical manner about the core (2).

13. A musical string (1) according to one of the claims 1 to 12, characterized in that said musical string (1) comprises a second sheathing (6) which is wound in a helical manner about the first sheathing (3).

14. A musical string (1) according to claim 13, characterized in that the second sheathing (6) is arranged in a crossed manner relative to the first sheathing (3).

15. A musical string (1) according to claim 13 or 14, characterized in that the second sheathing (6) is formed by at least a third round wire.

16. A musical string (1) according to claim 15, characterized in that the second sheathing (6) further comprises a fourth round wire, and that the third round wire and the fourth round wire are wound adjacent to one another in a helical manner about the core (2).

17. A musical string (1) according to one of the claims 13 to 16, characterized in that the second sheathing (6) is formed by at least a third strip (7) with a substantially rectangular cross section with predeterminable edge formation.

18. A musical string (1) according to claim 17, characterized in that the second sheathing (6) further comprises a fourth strip with a substantially rectangular cross section with predeterminable edge formation, and that the third strip (7) and the fourth strip are wound adjacent to one another in a helical manner about the core (2).

19. A musical string (1) according to one of the claims 13 to 18, characterized in that said musical string (1) comprises at least a third sheathing which is wound in a helical manner about the second sheathing (6).

20. A musical string (1) according to claim 19, characterized in that the third sheathing is arranged in a crossed manner relative to the second sheathing (6).

21. A musical string (1) according to one of the claims 9 to 20, characterized in that the at least one round wire has a diameter of between 0.05 mm and 0.4 mm.

22. A musical string (1) according to one of the claims 11 to 19, characterized in that the at least one strip (5, 7) is between 1.25 and 30 times as wide as thick.

23. A musical string (1) according to one of the claims 9 to 22, characterized in that the at least one round wire or the at least one strip (5, 7) is formed by at least one material chosen from the group of aluminum, magnesium, iron, chromium, nickel, silicon, silver, gold, platinum, rhodium, copper, tungsten.

24. A musical string (1) according to one of the claims 9 to 23, characterized in that the at least one round wire or the at least one strip (5, 7) is formed to comprise at least one alloy chosen from the group of steel, aluminum/magnesium alloys, aluminum/magnesium/manganese alloys, silver/copper alloys, silver/platinum alloys, silver/palladium alloys, silver/rhodium alloys, iron/chromium/nickel/silicon/aluminum alloys.

25. A musical string (1) according to one of the claims 9 to 24, characterized in that the at least one round wire or the at least one strip (5, 7) has a surface coating.

26. A musical string (1) according to one of the claims 13 to 25, characterized in that at least between the first sheathing (3) and the second sheathing (6) a bonding agent is arranged, preferably comprising wax, especially natural and/or synthetic waxes, paraffin, oil, resin, especially natural and/or synthetic resins.

27. A musical string (1) according to one of the claims 1 to 26, characterized in that an intermediate layer comprising polyamide is arranged between the core (2) and the first sheathing (3).

28. A musical string (1) according to claim 27, characterized in that the intermediate layer is formed by a bundle comprising a predeterminable number of polyamide fibers, and that the bundle is wound in a helical manner about the core (2).

29. A musical string (1) according to one of the claims 13 to 28, characterized in that the first sheathing (3) is formed by a first strip (5) and the second sheathing (6) by a third strip (7), that the first and third strip (5, 7) are formed by an aluminum/magnesium alloy, preferably one and the same, or aluminum/magnesium/manganese alloys, that the first and third strip (5, 7) have cross sections which are substantially identical with respect to each other, that the first and third strip (5, 7) are between 1.7 and 5.5 times as wide as thick, and that the third strip (7) is arranged in a crossed manner relative to the first strip (5).

30. A musical string (1) according to one of the claims 13 to 28, characterized in that the first sheathing (3) is formed by a first and second round wire which are wound adjacent to one another in a helical manner about the core (2), that the first and second round wire have a substantially identical diameter in respect of each other of between 0.1 mm and 0.2 mm, that the second sheathing (6) is formed by a third strip (7) which is between 1.5 and 5.5 times as wide as thick.

31. A musical string (1) according to claim 30, characterized in that the first and second round wire are made of steel.

32. A musical string (1) according to claim 30 or 31, characterized in that the third strip (7) is formed by an iron/chromium/nickel/silicon/aluminum alloy and is between 1.5 and 2.2 times wide as thick.

33. A musical string (1) according to one of the claims 13 to 28, characterized in that the first sheathing (3) is formed by a first strip (5) and a second strip which are wound adjacent to one another in a helical manner about the core (2), that the first strip (5) and the second strip are between 3 and 8 times as wide as thick, and that the second sheathing (6) is formed by a third strip (7).
